(19) United States
(12) Patent Application Publication
(10) Pub. No.: US 2023/0400030 A1
(43) Pub. Date: Dec. 14, 2023

(54) TURBOMOLECULAR VACUUM PUMP AND METHOD FOR MANUFACTURING A ROTOR

(71) Applicant: PFEIFFER VACUUM, Annecy (FR)

(72) Inventors: Pierre-Emmanuel CAVAREC, Annecy (FR); Romain CRIADO, Annecy (FR); François ROGER, Annecy (FR); Eric DULAC, Annecy (FR)

(73) Assignee: PFEIFFER VACUUM, Annecy (FR)

(21) Appl. No.: 18/249,269

(22) PCT Filed: Jun. 23, 2021
(86) PCT No.: PCT/EP2021/067171

§ 371 Date: Apr. 17, 2023

(30) Foreign Application Priority Data
Nov. 19, 2020 (FR) FR2011896

(51) Int. Cl. F04D 19/04; F04D 29/32

(52) U.S. Cl. CPC F04D 19/04; F04D 29/321; F04D 29/584

(57) ABSTRACT

A turbomolecular vacuum pump drives gases to be pumped from a suction orifice to a discharge orifice. In the turbomolecular vacuum pump, the surface of the internal bowl of the rotor arranged facing the shell of the stator capable of being cooled exhibits a higher emissivity than the outer surface of the rotor in fluidic communication with the pumped gases and/or the surface of the shell of the stator capable of being cooled arranged facing the internal bowl of the rotor exhibits a higher emissivity than the outer surface of the rotor in fluidic communication with the pumped gases.

The present invention relates to a turbomolecular vacuum pump. The present invention also relates to a method for manufacturing a turbomolecular vacuum pump rotor.

The generation of a high vacuum in an enclosure requires the use of turbomolecular vacuum pumps composed of a stator in which a rotor is driven in rapid rotation, for example a rotation at more than ninety thousand revolutions per minute.

In some methods in which the turbomolecular vacuum pumps are used, such as the methods for manufacturing semiconductors or LEDs, a deposition layer can be formed in the vacuum pump. This deposition can result in a restriction of play between the stator and the rotor potentially provoking a ceasing of the rotor. A deposition layer in fact heats up the rotor by friction, which can generate creep thereof followed by a possible cracking.

It is known practice to heat the stator to avoid the condensation of reaction products in the pump. However, care is taken to ensure that the temperature of the rotor does not exceed a certain high threshold in order to preserve its mechanical strength. Indeed, the mechanical resistance to the centrifugal forces of the rotor diminishes when the temperature increases, notably beyond 150° C. for aluminium.

The increased operating temperature of the vacuum pump also means limiting the maximum pumped flow of gas to maintain a temperature of the rotor that is compatible with its operating specifications because the greater the flow of gas to be pumped, the more the vacuum pump heats up.

These constraints on the operating temperature and on the maximum flow of gas do however conflict with product expectations. It is in fact sought to increase the heating temperature as far as possible to limit the formation of deposition and thus increase the lifespan of the pumps. At the same time, it is sought to maximally increase the flow of pumped gases to increase the production rates, and in particular the flow of heavy gas, such as argon.

The heavy gases do however present the drawback of provoking an even greater heating of the rotor. In fact, the dissipation of the heat of the rotor is achieved on the one hand by transfer to the molecules (convection) and on the other hand by infrared radiation. However, in the case of the pumping of heavy gases, the heat exchanges by convection are very much reduced.

Moreover, since the process gases can be very aggressive, it may be necessary to protect the rotor by coating it with a protective layer, such as a nickel plating. The nickel coating does however exhibit a very low infrared emissivity, of the order of 0.2. This low emissivity greatly limits the heat exchanges between the rotor and its environment, which consequently restricts the maximum flow of gas that can be pumped.

One of the aims of the present invention is to propose a turbomolecular vacuum pump that at least partially resolves a drawback of the state of the art.

To this end, the subject of the invention is a turbomolecular vacuum pump configured to drive gases to be pumped from a suction orifice to a discharge orifice, the turbomolecular vacuum pump comprising:
a stator comprising at least one fin stage and a shell configured to be able to be cooled,
a rotor configured to revolve in the stator and comprising at least two blade stages, the blade stages and the fin stages following one another axially along an axis of rotation of the rotor and an internal bowl coaxial to the axis of rotation, arranged facing the shell of the stator,
a purging device configured to inject a flow of purging gas into the gap situated between the shell of the stator and the internal bowl of the rotor,
characterized in that the surface of the internal bowl of the rotor arranged facing the shell of the stator capable of being cooled, exhibits a higher emissivity than the outer surface of the rotor in fluidic communication with the pumped gases, at least over a portion of the surface of the internal bowl, and the outer surface of the rotor in fluidic communication with the pumped gases exhibits a lower emissivity than the surface of the internal bowl of the rotor, at least over a portion of the surface of the internal bowl,
and/or the surface of the shell of the stator capable of being cooled, arranged facing the internal bowl of the rotor, exhibits a higher emissivity than the outer surface of the rotor in fluidic communication with the pumped gases, at least over a portion of the surface of the shell of the stator, and the outer surface of the rotor in fluidic communication with the pumped gases exhibits a lower emissivity than the surface of the shell of the stator, at least over a portion of the surface of the shell of the stator.

In radiative transfer, the emissivity corresponds to the radiative flow of the thermal radiation emitted by a surface element at given temperature, ratioed to the reference value that is the flow emitted by a black body at this same temperature.

Most of the surface of the internal bowl, such as the entire surface of the internal bowl apart from centring surfaces, and/or most of the surface of the shell of the stator, such as the entire surface of the shell of the stator apart from centring surfaces, exhibits, for example, a higher emissivity.

The surface or surfaces of high emissivity exhibit, for example, an emissivity greater than or equal to 0.4.

The surface or surfaces in fluidic communication with the pumped gases can exhibit an emissivity less than 0.3. In particular, the outer surface of the rotor in fluidic communication with the pumped gases can have a protective coating against corrosion, such as a nickel plating.

The inside of the rotor, and only the inside, having a surface of high emissivity, makes it possible to promote the radiative cooling of the rotor by heat dissipation. The shell of the stator under the rotor, having a surface of high emissivity, makes it possible to promote the cooling of the rotor by radiative radiation from the shell which is itself cooled.

The turbomolecular vacuum pump can comprise a cooling device configured to cool the shell of the stator and/or a heating device configured to heat a sleeve of the stator surrounding the rotor.

The sleeve of the stator, surrounding the rotor, is heated to avoid the formation of depositions on the inner surfaces of the stator. The heat exchanges between the sleeve and the rotor are reduced by the outer surfaces of the rotor of low emissivity, in order not to heat up the rotor.

The shell of the stator, projecting under the rotor, is cooled to protect the electronic components and the motor under the rotor. The heat exchanges between the shell and the rotor are promoted by surfaces of the internal bowl of the rotor and/or of the shell of the stator, of high emissivity in order to better cool the rotor.

To significantly enhance the heat exchanges, surfaces of high emissivity both on the moving part and on the fixed part in the region which does not connect directly with the pumped gases may be preferred.

The section of the annular conductance between an end of the internal bowl of the rotor and the shell of the stator is for example less than or equal to 12 mm²/1.69×10⁻³ Pa·m³/s of injected purging gas flow (12 mm²/sccm) in order to limit the entry of the pumped gases into the gap situated between the shell of the stator and the internal bowl of the rotor and in order to protect the surface or surfaces of higher emissivity situated between the internal bowl of the rotor and the shell of the stator.

The flow rate of purging gas is for example less than or equal to 0.0845 Pa·m³/s (or 50 sccm).

In operation, the heat exchanges with the shell of the stator are promoted under the rotor because of the surface or surfaces of high emissivity, which allows the radiative cooling of the rotor to be enhanced. These surfaces of high emissivity do not see the potentially corrosive pumped gases because they are protected on the one hand by the purging gas circulating in the gap under the rotor and, on the other hand, by the annular conductance at the end of the internal bowl. The purging gas and the annular conductance make it possible to protect the surfaces of high emissivity of the rotor and/or of the stator from the possible aggressions of the pumped gases which could infiltrate under the rotor. Thus, only the protected surfaces are made highly emissive so that they do not encounter or encounter little of the potentially corrosive pumped gases.

The turbomolecular vacuum pump can, furthermore, comprise one or more of the features which are described hereinbelow, taken alone or in combination.

The surface or surfaces of high emissivity of the internal bowl of the rotor and/or of the shell of the stator is or are, for example, obtained by surface treatment, such as by anodization or sandblasting or grooving or texturing, for example by laser, or soda-treated. Surface treatment of aluminium by anodization, soda-treatment or laser texturing has the advantage of being able to obtain surfaces of emissivity greater than 0.8 at a reasonable cost.

The surface or surfaces of high emissivity of the internal bowl of the rotor and/or of the shell of the stator can be obtained by deposition of a coating, such as a plasma-deposited chemical coating of KEPLA-COAT® type or such as a coating of paint type without solvents, such as an epoxy polymer coating, more commonly called “epoxy paint”. The fact that only the surfaces of the internal bowl of the rotor, notably of the Holweck skirt, can have a coating of high emissivity offers the advantage that the fastness of the coating of the rotor is reinforced by the pressing effect of the centrifugal force.

The thickness of the coating for example lies between 30 μm and 100 μm.

The coating or the surface treatment for example has a matt and/or dark appearance.

It is notably possible to provide several surface treatments and/or coating layers to increase the emissivity of the rotor and/or of the stator in the gap.

The coating or the surface treatment is preferably solvent-free. The solvents are in fact totally to be prescribed in certain pumping applications and it is preferred not to use solvents in the vacuum pump to avoid any risk of backscattering into the enclosures to be pumped.

The purging device can be configured to inject a flow of purging gas at at least one bearing supporting and guiding a drive shaft of the rotor so that the flow of purging gas passes through the at least one bearing before exiting from the shell of the stator.

The turbomolecular vacuum pump can comprise a sensor of presence of the purging gas injected by the purging device.

The vacuum pump comprises, for example, a cooling device received in the stator, in the shell or in thermal contact with the shell, such as a hydraulic circuit, to cool the shell of the stator. The cooling device for example makes it possible to control the temperature of the shell at a temperature less than or equal to 75° C., such as 70° C., for example by circulation of water at ambient temperature.

Advantageously, the turbomolecular vacuum pump comprises a temperature sensor configured to measure the temperature of the rotor by infrared radiation. The temperature sensor can be placed on the shell of the stator, facing the surface of high emissivity of the internal bowl.

The heating device of the stator is, for example, a heating resistive belt, configured to heat the sleeve of the stator to a setpoint temperature, for example greater than 80° C., such as 130° C.

According to an exemplary embodiment, the rotor comprises a Holweck skirt downstream of the at least two blade stages, the Holweck skirt being formed by a smooth cylinder configured to revolve opposite helical grooves of the stator for the pumping of the gases, the internal bowl arranged facing the shell of the stator being also formed by the interior of the Holweck skirt.

According to another example, the vacuum pump is only turbomolecular: the rotor comprises at least two blade stages but no Holweck skirt.

Another subject of the invention is a method for manufacturing a turbomolecular vacuum pump rotor as described previously, wherein:
the outer surface of the rotor is treated to obtain a surface of high emissivity of the rotor, apart from centring surfaces, or, a coating is deposited on the rotor to obtain a surface of high emissivity of the rotor, apart from centring surfaces, then
the outer surface of the rotor intended to be in fluidic communication with the pumped gases is nickel-plated, by masking the internal bowl of the rotor.

Another subject of the invention is a method for manufacturing a turbomolecular vacuum pump rotor as described previously, wherein:
a surface treatment of a first part of the rotor, comprising the internal bowl and the Holweck skirt, is performed to obtain a surface of high emissivity of the first part of the rotor, or, a coating is deposited on a first part of the rotor comprising the internal bowl and the Holweck skirt to obtain a surface of high emissivity of the first part of the rotor, then
the surface of the first part of the rotor intended to be in fluidic communication with the pumped gases is nickel-plated by masking the internal bowl, then, the first part of the rotor is fixed with a nickel-plated second part of the rotor, comprising at least two blade stages.

Another subject of the invention is a method for manufacturing a turbomolecular vacuum pump rotor as described previously, wherein a piece forming the internal bowl with surface of high emissivity is assembled, for example by screwing or interference fit, with a rotor body having, on the one hand, a concave form complementing the internal bowl and comprising, on the other hand, at least two blade stages. The piece forming the internal bowl with surface of high emissivity is for example made of anodised aluminium.

### DESCRIPTION OF THE DRAWINGS

Other advantages and features will become apparent on reading the following description of a particular, but nonlimiting, embodiment of the invention, and the attached drawings in which:

FIG. 1 shows an axial cross-sectional view of a turbomolecular vacuum pump according to a first exemplary embodiment.

FIG. 2 shows a cross-sectional view of another exemplary embodiment of a turbomolecular vacuum pump rotor.

FIG. 3 shows a cross-sectional view of another exemplary embodiment of a turbomolecular vacuum pump rotor.

FIG. 4 shows an axial cross-sectional view of a turbomolecular vacuum pump according to another exemplary embodiment.

In these figures, identical elements bear the same reference numbers.

The following embodiments are examples. Although the description refers to one or more embodiments, this does not necessarily mean that each reference relates to the same embodiment, or that the features apply only to a single embodiment. Simple features of different embodiments can also be combined or swapped to provide other embodiments.

“Upstream” is understood to mean an element which is placed before another with respect to the direction of circulation of the gas. On the other hand, “downstream” is understood to mean an element placed after another with respect to the direction of circulation of the gas to be pumped.

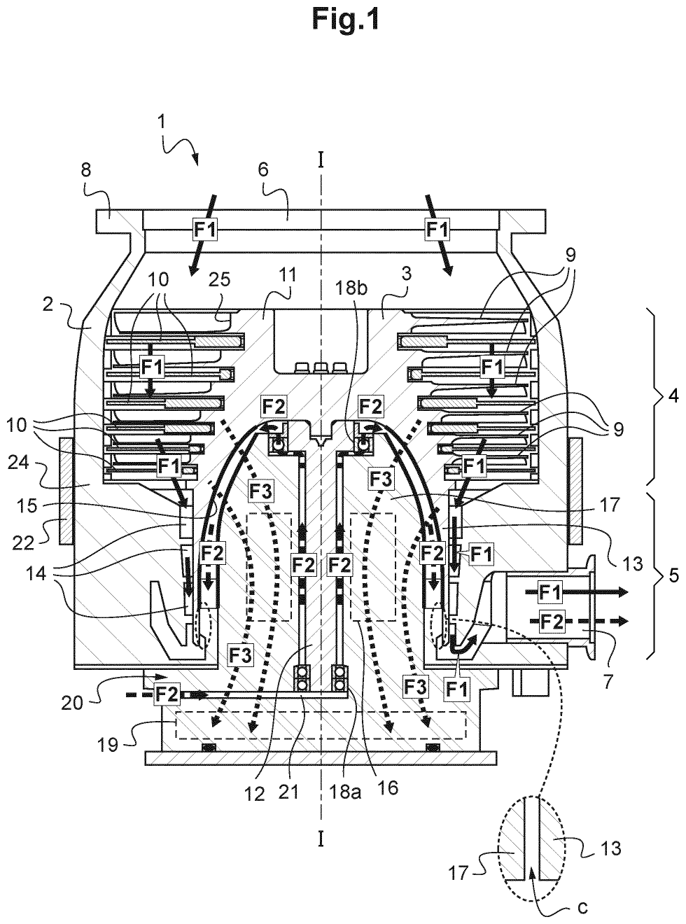

FIG. 1 illustrates a first exemplary embodiment of a turbomolecular vacuum pump 1.

The turbomolecular vacuum pump 1 comprises a stator 2 in which a rotor 3 is configured to revolve at high speed in axial rotation, for example a rotation at more than ninety thousand revolutions per minute.

In the exemplary embodiment of FIG. 1, the turbomolecular vacuum pump 1 is said to be hybrid: it comprises a turbomolecular stage 4 and a molecular stage 5 situated downstream of the turbomolecular stage 4 in the direction of circulation of the pumped gases (represented by the arrows F1 in FIG. 1). The pumped gases enter through the suction orifice 6, pass first of all through the turbomolecular stage 4, then the molecular stage 5, to be then discharged to a discharge orifice 7 of the turbomolecular vacuum pump 1. In operation, the discharge orifice 7 is connected to a primary pumping.

An annular input flange 8 for example surrounds the suction orifice 6 to connect the vacuum pump 1 to an enclosure for which there is a desire to lower the pressure.

In the turbomolecular stage 4, the rotor 3 comprises at least two blade stages 9 and the stator 2 comprises at least one fin stage 10. The blade 9 and fin 10 stages follow one another axially along the axis of rotation I-I of the rotor 3 in the turbomolecular stage 4. The rotor 3 comprises, for example, more than four blade stages 9, such as, for example, between four and twelve stages 9 (seven in the example illustrated in FIG. 1).

Each blade stage 9 of the rotor 3 comprises inclined blades which leave in a substantially radial direction from a hub 11 of the rotor 3 fixed to a drive shaft 12 of the vacuum pump 1, for example by screwing. The blades are distributed regularly on the periphery of the hub 11.

Each fin stage 10 of the stator 2 comprises a crown ring from which inclined fins, distributed regularly over the inner perimeter of the crown ring, leave in a substantially radial direction. The fins of a fin stage 10 of the stator 2 engage between the blades of two successive blade stages 9 of the rotor 3. The blades 9 of the rotor 3 and the fins 10 of the stator 2 are inclined to guide the pumped gas molecules to the molecular stage 5.

The rotor 3 further comprises an internal bowl 15, coaxial to the axis of rotation I-I and arranged facing a shell 17 of the stator 2, projecting under the rotor 3. In operation, the rotor 3 revolves in the stator 2 without contact between the internal bowl 15 and the shell 17.

Here, in the molecular stage 5, the rotor 3 further comprises a Holweck skirt 13 downstream of the at least two blade stages 9, formed by a smooth cylinder, which revolves opposite helical grooves 14 of the stator 2. The helical grooves 14 of the stator 2 make it possible to compress and guide the pumped gases to the discharge orifice 7. Under the rotor 3, the internal bowl 15 arranged facing the shell 17 of the stator 2 is then also formed by the interior of the Holweck skirt 13.

The rotor 3 can be produced in a single piece (monobloc) or it can be an assembly of several pieces. It is for example made of aluminium material and/or of nickel.

It is fixed to a drive shaft 12, for example by screwing, driven in rotation in the stator 2 by an internal motor 16 of the vacuum pump 1. The motor 16 is, for example, arranged in the shell 17 of the stator 2, which is itself arranged under the internal bowl 15 of the rotor 3, the drive shaft 12 passing through the shell 17 of the stator 2.

The rotor 3 is guided laterally and axially by magnetic or mechanical bearings 18a, 18b supporting the drive shaft 12 of the rotor 3, situated in the stator 2. There are for example first bearings 18a supporting and guiding a first end of the drive shaft 12 in a base of the shell 17 of the stator 2 and second bearings 18b supporting and guiding a second end of the drive shaft 12 arranged at the top of the shell 17.

Other electrical or electronic components can be received in the shell 17 of the stator 2, such as, for example, position sensors or a sensor of presence of purging gas as will be seen later.

The shell 17 is configured to be able to be cooled in order to be able to continually cool the elements that it contains, such as, in particular, the bearings 18a, 18b, the motor 16 and other electrical or electronic components, in order to allow them to operate. For that, the vacuum pump 1 comprises, for example, a cooling device 19 configured to cool the shell 17 of the stator 2, for example received in the stator 2, in the shell 17 or in thermal contact with the shell 17, such as a hydraulic circuit. The cooling device 19 makes it possible, for example, to control the temperature of the shell 17 at a temperature less than or equal to 75° C., such as 70° C., for example by circulation of water at ambient temperature.

The vacuum pump 1 further comprises a purging device 20 configured to inject a purging gas into the gap situated between the shell 17 of the stator 2 and the internal bowl 15 of the rotor 3. The purging gas is preferentially air or nitrogen, but can also be another neutral gas such as helium or argon. The flow rate of purging gas is low. It is for example less than or equal to 0.0845 Pa·m³/s (or 50 sccm). The vacuum pump 1 can comprise a sensor of presence of the purging gas injected by the purging device 20.

The purging device 20 is, for example, configured to inject a purging gas at at least one bearing 18a, 18b situated in the stator 2, supporting and guiding the drive shaft 12 of the rotor 3, such that the flow of purging gas passes through the at least one bearing 18a, 18b before exiting from the shell 17 of the stator 2 and circulating in the gap.

More specifically according to an exemplary embodiment, the purging device 20 comprises a duct 21 for bringing a purging gas into a cavity receiving the first bearings 18a supporting and guiding the first end of the drive shaft 12.

Furthermore, the section of the annular conductance c between the end of the rotor 3, here an annular end of the Holweck skirt 13, and the shell 17 of the stator 2, is less than or equal to 12 mm²/sccm of flow of injected purging gas or, in international units, 12 mm²/1.69×10⁻³ Pa·m³/s of flow of injected purging gas, in order to limit the entry of the pumped gases into the gap situated between the shell 17 of the stator 2 and the internal bowl 15 of the rotor 3 and, as will be seen later, in order to protect the surface or surfaces of greater emissivity situated between the internal bowl 15 of the rotor 3 and the shell 17 of the stator 2. Sccm is a gas flow unit (standard cubic centimetres per minute, at 101500 Pa; 1 sccm=1.69×10⁻³ Pa·m³/s in international units).

For example, if the purging flow rate is 50 sccm (0.0845 Pa·m³/s), the section of the conductance must be less than or equal to 600 mm². Likewise, if the section of conductance is 300 mm², the flow of injected purging gas must be greater than or equal to 25 sccm (42.25×10⁻³ Pa·m³/s).

The flow of purging gas and the associated annular conductance also make it possible to protect the journal-bearing elements of the turbomolecular vacuum pump 1, in particular the electrical connections, the welds and the bearings 18a, 18b, from the partially aggressive pumped gases by forming a barrier limiting the entry of the pumped gases under the rotor 3.

In operation and as schematically represented in the example of FIG. 1, the purging gas passes through the first bearings 18a, rises along the drive shaft 12 and passes through the second bearings 18b supporting and guiding the second end of the drive shaft 12 to exit from the shell 17 of the stator 2 and circulating the gap situated between the shell 17 and the internal bowl 15, then under the Holweck skirt 13, to pass through the annular conductance c between the rotor 3 and the stator 2 and rejoin the pumped gases at the discharge of the vacuum pump 1 (arrows F2 in FIG. 1).

The turbomolecular vacuum pump 1 can comprise a heating device 22 for heating the stator 2, such as a heating resistive belt, configured to heat a sleeve 24 of the stator 2 surrounding the rotor 3, to a setpoint temperature, for example greater than 80° C., such as 130° C.

The surface of the internal bowl 15 of the rotor 3 arranged facing the shell 17 of the stator 2 capable of being cooled, exhibits a higher emissivity than the outer surface 25 of the rotor 3 in fluidic communication with the pumped gases, at least over a portion of the surface of the internal bowl 15, and the outer surface 25 of the rotor 3 in fluidic communication with the pumped gases exhibits a lower emissivity than the surface of the internal bowl 15 of the rotor 3, at least over a portion of the surface of the internal bowl 15.

As an alternative or in addition, the surface of the shell 17 of the stator 2 capable of being cooled, arranged facing the internal bowl 15 of the rotor 3, exhibits a higher emissivity than the outer surface 25 of the rotor 3 in fluidic communication with the pumped gases, at least over a portion of the surface of the shell 17 of the stator 2, and the outer surface 25 of the rotor 3 in fluidic communication with the pumped gases exhibits a lower emissivity than the surface of the shell 17 of the stator 2, at least over a portion of the surface of the shell 17 of the stator 2.

Most of the surface of the internal bowl 15, such as the entire surface of the internal bowl 15 apart from centring surfaces, and/or most of the surface of the shell 17 of the stator 2, such as the entire surface of the shell 17 of the stator 2 apart from centring surfaces, exhibits, for example, a higher emissivity.

The surface or surfaces of high emissivity exhibit, for example, an emissivity greater than or equal to 0.4, such as greater than or equal to 0.8. The surface or surfaces in fluidic communication with the pumped gases exhibit, for example, an emissivity less than 0.3, such as an emissivity of 0.2, notably for a rotor 3 made of aluminium, of nickel or nickel-coated.

The interior of the rotor 3, and only the interior, having a surface of high emissivity, makes it possible to promote the radiative cooling of the rotor 3 by heat dissipation. The shell 17 of the stator 2 under the rotor 3, having a surface of high emissivity, makes it possible to promote the cooling of the rotor 3 by radiative radiation from the shell 17 which is itself cooled. The heat flux is schematically represented by the arrows F3 in FIG. 1.

The sleeve 24 of the stator 2, surrounding the rotor 3, can be heated to avoid the formation of deposition on the inner surfaces of the stator 2. The heat exchanges between the sleeve 24 and the rotor 3 are reduced by outer surfaces of the rotor 3 of low emissivity in order not to heat up the rotor 3.

The shell 17 of the stator 2, projecting under the rotor 3, is cooled to protect the electronic components and the motor under the rotor 3. The heat exchanges between the shell 17 and the rotor 3 are promoted by surfaces of the internal bowl 15 of the rotor 3 and/or of the shell 17 of the stator 2, of high emissivity in order to better cool the rotor 3.

To significantly enhance the heat exchanges, surfaces of high emissivity can be prioritised both on the moving part (internal bowl 15) and on the fixed part (shell 17) in the region which does not connect directly with the pumped gases.

The outer surface 25 of the rotor 3 in fluidic communication with the pumped gases can exhibit a low emissivity. In particular, this outer surface 25 of the rotor 3 in fluidic communication with the pumped gases can have a protective coating against corrosion, such as a nickel-plating.

The surface or surfaces of high emissivity of the internal bowl 15 of the rotor 3 and/or of the shell 17 of the stator 2 is or are for example obtained by surface treatment, such as by anodization or sand-blasting or grooving or texturing, for example by laser, or soda-treated to be blackened. The surface treatment of the aluminium by anodization, soda-treatment or laser offer the advantage of being able to obtain surfaces of emissivity greater than 0.8 at reasonable cost.

As an alternative or in addition, the surface or surfaces of high emissivity of the internal bowl 15 of the rotor 3 and/or of the shell 17 of the stator 2 is or are obtained by deposition of a coating, such as a plasma-deposited chemical coating of KEPLA-COAT® type or such as a coating of paint type without solvents, such as an epoxy polymer coating, more commonly called “epoxy paint”. The fact that only the surfaces of the internal bowl of the rotor 3 can have an epoxy polymer coating of high emissivity offers the advantage that the fastness of the coating is reinforced by the pressing effect of the centrifugal force.

Preferentially, the painted or coated surfaces are limited to the surfaces parallel to the axis of rotation I-I of rotor 3 in order for the centrifugal force not to be able to tear off the paint or the coating, such as, for example, the cylindrical surfaces of the internal bowl 15, notably of the Holweck skirt 13. The thickness of the coating for example lies between 30 μm and 100 μm.

The coating or surface treatment can have a preferably matt and/or dark appearance, such as black or a shade of black.

It is notably possible to provide several surface treatments and/or coating layers to increase the emissivity of the rotor 3 and/or of the stator 2 in the gap.

The coating or the surface treatment is preferably solvent-free. The solvents are in fact totally to be prescribed in certain pumping applications and it is preferred not to use solvents in the vacuum pump 1 to avoid any risk of backscattering into the enclosures to be pumped.

According to a first exemplary embodiment of the rotor 3, the first step is to perform an outer surface treatment 25 of the rotor 3 to obtain a surface of high emissivity of the rotor 3, apart from centring surfaces, or, to deposit a coating on the rotor 3 to obtain a surface of high emissivity of the rotor 3, apart from centring surfaces. The centring surfaces allow the rotor 3 to be centred with the drive shaft 12 on the axis of rotation I-I and therefore require greater production precision. Then, secondly, the outer surface 25 of the rotor 3 intended to be in fluidic communication with the pumped gases is nickel-plated, by masking the internal bowl 15 of the rotor 3.

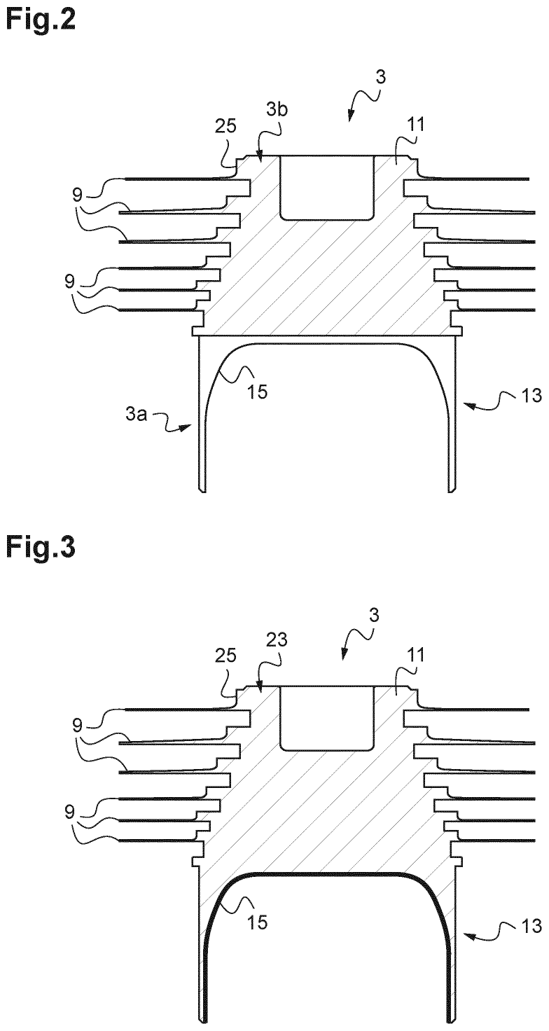

According to a second exemplary embodiment of the rotor 3, a surface treatment of a first part 3a of the rotor 3 comprising the internal bowl 15 and the Holweck skirt 13 is performed to obtain a surface of high emissivity of the first part of the rotor 3, or, a coating is deposited on a first part of the rotor 3 comprising the internal bowl 15 and the Holweck skirt 13 to obtain a surface of high emissivity of the first part of the rotor 3 (FIG. 2). Then, the surface of the first part of the rotor 3 intended to be in fluidic communication with the pumped gases is nickel-plated by masking the internal bowl 15. Then, the first part 3a of the rotor 3 is fixed, for example by screwing, with a nickel-plated second part 3b of the rotor 3, comprising at least two blade stages 9.

According to a third exemplary embodiment, a piece forming the internal bowl 15 with surface of high emissivity is assembled, for example by screwing or interference fit, with a rotor body 23 having, on the one hand, a concave form complementing the internal bowl 15 for the assembly of the internal bowl 15 and comprising, on the other hand, at least two blade stages 9 (FIG. 3). The piece forming the internal bowl 15 with surface of high emissivity is, for example, made of anodised aluminium.

In operation, the heat exchanges with the shell 17 of the stator 2 are promoted under the rotor 3 by virtue of the surface or surfaces of high emissivity, which makes it possible to enhance the radiative cooling of the rotor 3. These surfaces of high emissivity do not see the potentially corrosive pumped gases because they are protected, on the one hand, by the purging gas circulating in the gap under the rotor 3 and, on the other hand, by the annular conductance at the end of the internal bowl 15. The purging gas and the annular conductance make it possible to protect the surfaces of high emissivity of the rotor 3 and/or of the stator 2 from potential aggressions from the pumped gases which could infiltrate under the rotor 3. Thus, only the protected surfaces are made highly emissive so that they encounter little or none of the potentially corrosive pumped gases. The saving in terms of cost is significant because the purging flow and the low conductance allow surfaces of high emissivity to be produced relatively simply and therefore inexpensively. It is found for example that the radiative cooling of the rotor 3 promoted by the surfaces of high emissivity of the rotor 3 and of the stator 2 under the rotor 3, combined with a flow of purging gas between the rotor 3 and the stator 2, make it possible to increase the flow of pumped heavy gases from 20% to 30% for a shell 17 cooled to 70° C.

As an example, and for a better understanding of the invention, if the following designations are used:
Pᵣₛ, the thermal power radiated from the rotor 3 to the stator 2,
Tᵣ, the temperature of the rotor 3 (in K),
Tₛ, the temperature of the shell 17 of the stator 2 (in K),
εᵣ, the emissivity of the internal bowl 15 of the rotor 3,
εₛ, the emissivity of the bell 17 of the stator 2,
Sₛᵣ, the facing surface between the internal bowl 15 of the rotor 3 and the bell 17 of the stator 2,
then the power radiated by the rotor 3 to the stator 2 is:

P1=Sₛᵣ·εᵣ·σ·Tᵣ⁴
with σ=5.67×10⁻⁸ W·m⁻²·K⁻⁴ the Stefan-Boltzmann constant (emission constant of black bodies),
the power reflected by the stator 2 is:

P2=(1−σₛ)·P1

the power radiated by the stator 2 to the rotor 3 is:

P3=Sₛᵣ·εₛ·σ·Tₛ⁴

the power reflected by the rotor 3 is:

P4=(1−εᵣ)·P3

Consequently, the thermal power transmitted from the rotor 3 to the stator 2 is:

Pᵣₛ=P1−P2−P3+P4=Sₛᵣ·εᵣ·εₛ·σ·(Tᵣ⁴−Tₛ⁴)

Thus, if the surface Sₛᵣ is equal to 500 cm², the emissivity of the internal bowl 15 of the rotor 3 is 0.7 and that of the shell 17 is 0.8, and if the temperature of the rotor 3 is 150° C. and that of the shell 17 is 70° C. then the rotor 3 can transmit approximately 28 W.

On the other hand, if the emissivity of the shell 17 is no more than 0.2 then the transmitted power is no more than 7.2 W.

It will be understood from what has just been described that, to increase the flow of pumped gases, it is possible to increase the thermal power that can be dissipated from the rotor 3 by radiation by maximising the emissive surfaces Sₛᵣ opposite under the rotor 3, by maximising the emissivity of the surfaces of the internal bowl 15 of the rotor 3 and by maximising the emissivity of the surfaces of the shell 17 of the stator 2.

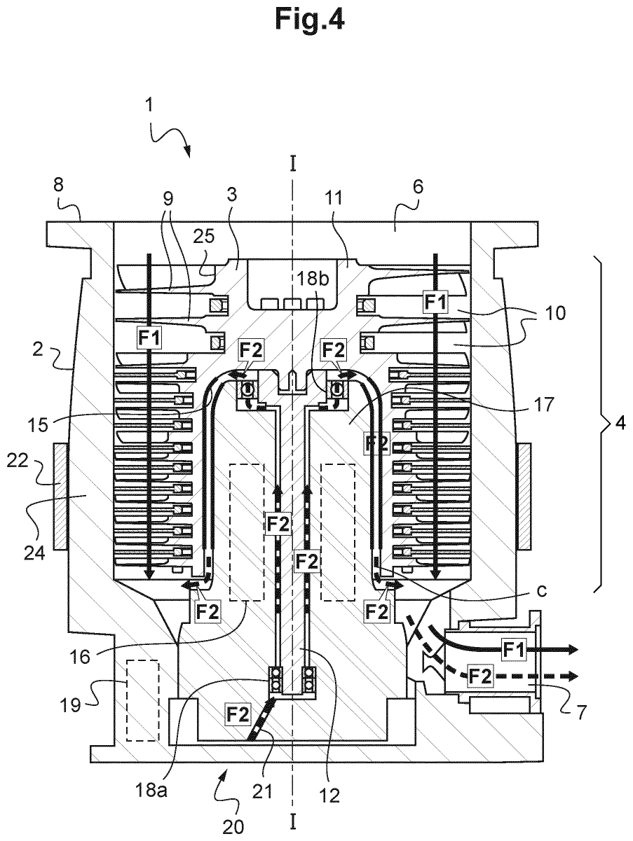

FIG. 4 also shows a second exemplary embodiment for which the vacuum pump 1 is only turbomolecular: the rotor 3 comprises at least two blade stages 9 but no Holweck skirt.

In this example, the section of the annular conductance c is constant over most of the height of the internal bowl 15.

As previously, the surface of the internal bowl 15 of the rotor 3 arranged facing the shell 17 of the stator 2 that is capable of being cooled, exhibits a higher emissivity than the outer surface 25 of the rotor 3 in fluidic communication with the pumped gases, at least over a portion of the surface of the internal bowl 15. As an alternative or in addition, the surface of the shell 17 of the stator 2 capable of being cooled arranged facing the internal bowl 15 of the rotor 3 exhibits a higher emissivity than the outer surface 25 of the rotor 3 in fluidic communication with the pumped gases, at least over a portion of the surface of the shell 17 of the stator 2.

In operation, as in the preceding example, the heat exchanges with the shell 17 of the stator 2 are promoted under the rotor 3 by virtue of surface or surfaces of high emissivity, which makes it possible to enhance the radiative cooling of the rotor 3. These surfaces of high emissivity do not see the potentially corrosive pumped gases because they are protected, on the one hand, by the purging gas circulating in the gap under the rotor 3 and, on the other hand, by the annular conductance at the end of the internal bowl 15. The purging gas and the annular conductance make it possible to protect the surfaces of high emissivity of the rotor 3 and/or of the stator 2 from the potential aggressions of the pumped gases which could infiltrate under the rotor 3. Thus, only the protected surfaces are made highly emissive so that they encounter little or none of the potentially corrosive pumped gases.

1-16. (canceled)

17. A turbomolecular vacuum pump configured to drive gases to be pumped from a suction orifice to a discharge orifice, the turbomolecular vacuum pump comprising:
a stator comprising:
at least one stage of fins, and
a shell configured to be cooled;
a rotor configured to revolve in the stator and comprising:
at least two blade stages, the blade stages and the fin stages following one another axially along an axis of rotation of the rotor, and
an internal bowl coaxial to the axis of rotation, arranged facing the shell of the stator;
a purging device configured to inject a flow of purging gas into a gap situated between the shell of the stator and the internal bowl of the rotor,
wherein at least one of:
a surface of the internal bowl of the rotor arranged facing the shell of the stator exhibits a higher emissivity than an outer surface of the rotor in fluidic communication with the pumped gases, at least over a portion of the surface of the internal bowl, and the outer surface of the rotor in fluidic communication with the pumped gas exhibits a lower emissivity than the surface of the internal bowl of the rotor, at least over a portion of the surface of the internal bowl, and
the surface of the shell of the stator arranged facing the internal bowl of the rotor exhibits a higher emissivity than the outer surface of the rotor in fluidic communication with the pumped gases, at least over a portion of the surface of the shell of the stator, and the outer surface of the rotor in fluidic communication with the pumped gases exhibits a lower emissivity than the surface of the shell of the stator, at least over a portion of the surface of the shell of the stator.

18. The turbomolecular vacuum pump according to claim 17, wherein a section of angular conductance between an end of the internal bowl of the rotor and the shell of the stator is less than or equal to 12 mm²/1.69×10⁻³ Pa·m³/s of purging gas flow injected in order to limit entry of the pumped gases into the gap situated between the shell of the stator and the internal bowl of the rotor and in order to protect the surface or surfaces of greater emissivity situated between the internal bowl of the rotor and the shell of the stator.

19. The turbomolecular vacuum pump according to claim 17, wherein the outer surface of the rotor in fluidic communication with the pumped gases has a coating for protection against corrosion.

20. The turbomolecular vacuum pump according to claim 19, wherein the coating is a nickel plating.

21. The turbomolecular vacuum pump according to claim 17, wherein the surface or surfaces of high emissivity exhibit an emissivity greater than or equal to 0.4.

22. The turbomolecular vacuum pump according to claim 17, wherein the surface or surfaces in fluidic communication with the pumped gases exhibit an emissivity less than 0.3.

23. The turbomolecular vacuum pump according to claim 17, wherein the surface or surfaces of high emissivity of the internal bowl of the rotor and/or of the shell of the stator is or are obtained by surface treatment.

24. The turbomolecular vacuum pump according to claim 23, wherein the surface treatment is anodization, sand-blasting, grooving, or texturing.

25. The turbomolecular vacuum pump according to claim 23, wherein the surface treatment is solvent-free.

26. The turbomolecular vacuum pump according to claim 17, wherein the surface or surfaces of high emissivity of the internal bowl of the rotor and/or of the shell of the stator is or are obtained by deposition of a coating.

27. The turbomolecular vacuum pump according to claim 26, wherein the coating is a plasma-deposited chemical coating or a coating without solvents.

28. The turbomolecular vacuum pump according to claim 26, wherein the coating has a matt and/or dark aspect.

29. The turbomolecular vacuum pump according to claim 17, wherein the purging device is configured to inject a flow of purging gas at at least one bearing supporting and guiding a drive shaft of the rotor such that the flow of purging gas passes through the at least one bearing before exiting from the shell of the stator.

30. The turbomolecular vacuum pump according to claim 17, further comprising a sensor of a presence of the purging gas injected by the purging device.

31. The turbomolecular vacuum pump according to claim 17, wherein further comprising a heating device configured to heat a sleeve of the stator surrounding the rotor.

32. The turbomolecular vacuum pump according to claim 17, wherein the rotor comprises a Holweck skirt downstream of the at least two blade stages, the Holweck skirt being formed by a smooth cylinder configured to revolve opposite helical grooves of the stator for the pumping of the gases, the internal bowl arranged facing the shell of the stator being also formed by the interior of the Holweck skirt.

33. A method for manufacturing a rotor of the turbomolecular vacuum pump according to claim 17, the method comprising:
performing an outer surface treatment of the rotor to obtain a surface of high emissivity of the rotor, apart from centering surfaces, or depositing a coating on the rotor to obtain the surface of high emissivity of the rotor, apart from the centering surfaces, then
nickel-plating the outer surface of the rotor intended to be in fluidic communication with the pumped gases by masking the internal bowl of the rotor.

34. A method for manufacturing a rotor of the turbomolecular vacuum pump according to claim 32, the method comprising:
performing a surface treatment of a first part of the rotor comprising the internal bowl and the Holweck skirt to obtain a surface of high emissivity of the first part of the rotor, or depositing a coating on the first part of the rotor comprising the internal bowl and the Holweck skirt to obtain the surface of high emissivity of the first part of the rotor, then
nickel-plating the surface of the first part of the rotor intended to be in fluidic communication with the pumped gases by masking the internal bowl, then
fixing the first part of the rotor with a nickel-plated second part of the rotor comprising at least two blade stages.

35. A method for manufacturing a rotor of the turbomolecular vacuum pump according to claim 17, the method comprising:
assembling a piece forming the internal bowl with a surface of high emissivity with a rotor body having a concave form complementing the internal bowl and comprising at least two blade stages.
